(19) United States
(12) Patent Application Publication
(10) Pub. No.: US 2007/0252006 A1
(43) Pub. Date: Nov. 1, 2007

(54) Method and apparatus for non-invasive laser based labeling of plant products

(75) Inventors: Richard D. Heck, Lucerne Valley, CA (US); Juan Gutierrez Ibarra, Alta Loma, CA (US); James B. Sheffler, Chino Hills, CA (US)

Correspondence Address: SUGHRUE MION, PLLC, 2100 PENNSYLVANIA AVENUE, N.W., SUITE 800, WASHINGTON, DC, 20037, US

(73) Assignee: SUNKIST GROWERS, INC

(21) Appl. No.: 11/414,263

(22) Filed: May 1, 2006

(51) Int. Cl. G06K 7/10

(52) U.S. Cl. 235/455

(57) ABSTRACT

A method and apparatus for labeling plant products based on laser activation of a color-changing compound is disclosed. In the preferred embodiment, a nozzle sprays a coating of photosensitive material containing color-changing chemical component. An optional drying station is set up to optimize homogeneity and adhesiveness of the color-changing coating. A laser equipped with beam steering optics is used to image the desired mark on the plant product by inducing a change of color in the photosensitive coating, without contacting the plant product skin and at a high speed. An optional nozzle sprays a sealant coating after printing, for extended durability of the imaged label. In addition, an optical sensor detects the incoming plant product, determines its size and sends information for selecting the proper label to be imaged. An additional optical sensor can be placed at the end of the process to verify the quality and legibility of the imaged label. The apparatus described can be extended to multiple marking stations, which can be controlled by a central computer to allow for dynamic updating of the desired label(s).

### FIELD OF THE INVENTION

The present invention relates in general to a method and apparatus for labeling the exterior of fresh plant products using color-change chemistry techniques. In particular, the invention concerns a method and apparatus for marking on plant products using an edible color-change based coating and a laser as a means for photo stimulation, without etching or burning the plant product peel or skin.

### BACKGROUND OF THE INVENTION

Labeling of plant products, such as fruit and vegetables, is an important practice in the plant product processing industry. The Produce Marketing Association (PMA) has established that about 80% of bulk and packaged plant product has some type of label. The information on the label may include the plant product type, inventory and pricing control, traceability data, and/or producer brand. Particularly common is an unique number assigned to every plant product sold in bulk known as price look up code (P.L.U.) In addition to serving as an identification code for grocery store inventory and check out procedures, the P.L.U. categorizes how the plant product was grown. Namely, conventionally grown plant products have a 4 digit P.L.U. number, whereas organically grown and genetically engineered plant products have a 5 digit P.L.U. For organically grown plant products, the 5 digit P.L.U starts with 9, and for genetically engineered plant products the 5 digit P.L.U. starts with 8. Although the P.L.U. is not a part of a regulatory system, it has become a standard not only for the United States plant product industry, but worldwide as well.

For the market of bulk plant products, the most common labeling scheme is the use of pre-printed adhesive labels (hereafter referenced generally as “stickers”) that are mostly used in high-speed plant product processing lines. The literature contains many methods for performing this task, but a typical of method is disclosed in U.S. Pat. No. 6,257,294 B1, issued Jul. 10, 2001 to Weisbeck, and the references cited therein. There, an applicator head picks up a sticker from a roll and then the head rotates towards the plant product and applies the sticker to the surface by exerting some pressure. Stickers have an advantage in that they can be applied to irregular surfaces and plant products of different sizes and surface shapes. In the multiple disclosed systems, the applicator may be in the form of a blade, a piston, etc. Although the adhesive material employed is edible, the stickers, which are generally made of paper or vinyl, are not. Consequently, the stickers must be removed before consumption and, in some instances, only hot water and washing can get rid of stubborn ones. Another inconvenience of the sticker scheme is on the side of the packinghouses. Stickers that lack adhesive or were misplaced by the applicator end up on the conveyor apparatus causing numerous problems. Also, sticker rolls frequently jam the applicator or get out of position. As a consequence, packinghouses devote extensive manual labor to keep these types of systems operating. In addition, due to recent concerns about the safety of the food supply, the PMA has issued some guidelines for growers who wish to introduce in their labels information for tracing the plant products based on the identity of growers and place of production. This will require a dynamic labeling scheme with criteria that conventional stickers may not be able to satisfy.

### DESCRIPTION OF THE RELATED ART

U.S. Pat. No. 4,784,714, issued to Shibata in 1988, discloses a method where the label is printed just before it is glued onto a product. The method prints the sticker with a thermal printing head requiring, as a consequence, that the sticker consists of thermal paper. This apparatus is convenient for labeling packaged food, but it not practical for fresh fruit or vegetable labeling.

Sunkist Growers, Inc. has been using ink stamp applicators for many years to label fruit where conventional stickers are not desirable. For example, this is the case for those lemon product customers that slice the fruit for drinks. The sticker cannot be cut easily and it is necessary to remove it. The ink applicator consists of a rubber stamp with the company's logo, and an ink repository that transfers the ink to the rubber stamp. As the lemon passes under the applicator, the label is transferred by contact. Although this labeling system has been operating for many years, it produces a poorly legible mark that is not very appealing, particularly as the size and shape of lemons can vary. It also lacks the dynamic and flexible labeling characteristics that the market requires.

To overcome these disadvantages, alternate schemes have been proposed. For instance, U.S. Pat. No. 5,660,747 and No. 5,897,797 granted to Drouillard and Kanner in August 1997 and April 1999, respectively, where a high-power laser equipped with beam steering optics is aimed directly at the plant product with enough exposure to produce an etching on the outer layers of the plant product skin. The localized etching is produced in the shape of small dots to finally generate a legible mark in a way very similar to conventional dot matrix printers. Although this scheme provides the desired dynamic labeling, it requires very precise laser induced etching to prevent either burning or too light of a mark to be noticed. The laser induced etching is influenced by a combination of laser intensity, exposure time, laser-to-plant product surface distance, surface contour, and the particular peel characteristics of the printed plant product. In practice, it is extremely difficult to control all these factors. Differences in plant product size and shape, different peel textures even within the same commodity, in addition to external factors such as humidity condensation or industrial plant product coatings, significantly affect the degree of etching during printing. If overexposed, the resulting etching may potentially reduce the plant product market yield due to peel dryness, induced decay, reduced shelf life, or other similar factors. Additionally, the energy required to induce the desired etching to the fruit skin requires that a high power carbon dioxide (CO2) laser (20 W or more) must be used in this application.

An edible color-changing material is described in U.S. Pat. No. 6,888,095, issued on May 3, 2005 to Khan. Several materials are disclosed there which are composed in general by an color-changing agent in the form of a metal salt, a polymer, or some other metal compounds, a binder agent, and a transporter in the form of a solvent. Such compounds are photosensitive to a specific wavelength in the infrared spectral region (10,600 nm) so when a CO2 laser—emitting at that wavelength-images a label onto the photosensitive compound, the compound reacts by changing color only in the irradiated areas creating a clear inscription. As disclosed in U.S. Pat. No. 6,888,095, the entire contents of which are incorporated herein by reference, different renditions of the color-changing material have been employed to inscribe on objects of uniform size and shape with stable, heat resistant exterior surfaces, for example, pharmaceutical products and food packages. The additives may be a polyhydroxy compound and a dehydrating agent, the agent typically being a metal salt of the type that removes OH groups from sugars, e.g. sucrose, starches, modified starches, cellulose, modified celluloses, etc. Examples of suitable metal salts are alkali metal, alkaline earth metal, iron oxide/salts and organometallics. When heated by the application of laser energy, the sugars will char or dehydrate, causing a color change. Other examples of materials that will give a color change by dehydration in the presence of a metal salt include: hydroxypropylcellulose, methylhydroxypropylcellulose, sodium carboxymethylcellulose and polyvinyl alcohol. Suitable metal salts for this purpose include: MgCl₂, Mg(OH)₂, CaO, FeO, Fe₂O₃, CaSiO₃, Zn acetate, ZnO and alumino-silicates

As explained in the patent, the elimination reaction alternatively may comprise dehalogenation, dehydrohalogenation or deacetylation, in which case the relevant functional group is a halogen atom or carboxyl group. Examples of additives for this purpose are vinyl polymers, typically in the present of a metal salt. Suitable polymers include: polyvinyl chloride (PVC), polyvinyl acetate, vinyl esters, vinyl chloride/acetate copolymer and vinyl chloride/maleate copolymer. Suitable metal compounds for this purpose include: ZnO, Zn salicylate, kaolin and CaSiO₃. Other additives may undergo deetherification. Thus, for example, ethyl cellulose and a metal salt will give a color upon irradiation.

The examples given in the patent are primarily of metal salt-induced elimination, but further embodiments include acid or base-induced dehydration, such that a color is generated using p-toluenesulphonic acid with PVOH (polyvinyl alcohol). Based on this information, other suitable materials will be known, or can be readily chosen or tested for their suitability, by those of ordinary skill in the art.

The examples in the patent are suitable for products having a uniform and repetitive surface structure in view of their manufacture according to close industry tolerances. However, the application of the principles of the patent to plant products, particularly those having inconsistent and widely variable shapes, sizes and surface features, has not been contemplated.

The method and apparatus described herein discloses a method that takes advantage of laser printing features like dynamic and sticker-less labeling, and overcomes the disadvantages held by the disclosed systems in U.S. Pat. No. 5,660,747 and No. 5,897,797, by mainly avoiding etching of the plant product skin, even where the plant products vary in size, shape or skin texture. The present invention uses instead an edible color changing material of the type described in U.S. Pat. No. 6,888,095 but is adapted to provide a mark or label on plant products having variable sizes, shapes and surface characteristics.

### SUMMARY OF THE INVENTION

In an exemplary and non-limiting embodiment of the present invention describes a method for labeling plant products based on laser activation of a color-changing compound. The method includes the steps of: conveying a plant product to plural locations, and detecting the presence of the plant product as it is conveyed. Then, a coating of a color change compound on at least a portion of a surface of the plant product as the plant product is conveyed. Then, the aforementioned coating is dried as the plant product is conveyed. Then, light is selectively applied to at least a portion of the surface coated with the color changing compound in order to create a desired label, mark or the like. Then, a protective wax coating is applied to the marked area.

As a further feature of the invention, a coat of sealant is sprayed over the previously coated area of the plant product, either prior to application of the light or after development of the label, mark or the like.

As yet another feature of the invention, the print quality of the mark, label or image is evaluated and an accept/reject category may be assigned. On the basis of that assignment, a plant product ejection to a predetermined location may be undertaken.

As yet another feature of the exemplary and non-limiting embodiment of the present invention, the apparatus for labeling plant products based on laser activation of a color-changing compound may include a conveying system in the form of a spool, cup, belt, or the like providing an encoding pulse and constant or variable transportation speed.

As yet another feature of the exemplary and non-limiting embodiment of the present invention, the apparatus for labeling plant products based on laser activation of a color-changing compound may include a drying unit consisting of a heating element and air blower.

As yet another feature of the exemplary and non-limiting embodiment of the present invention, the apparatus for labeling plant products based on laser activation of a color-changing compound may include a vision system consisting of suitable light emitter, a suitable light detector, a processing unit, and a control unit.

As yet another feature of the exemplary and non-limiting embodiment of the present invention, the apparatus for labeling plant products based on laser activation of a color-changing compound may include a CO2 laser with beam steering optics, and a laser control unit.

As yet another feature of the exemplary and non-limiting embodiment of the present invention, the apparatus for labeling plant products based on laser activation of a color-changing compound may include a delivery system consisting in an actuated nozzle(s) attached to a tank containing color changing material and optionally an additional purging tank containing cleaning solvent; an actuated nozzle(s) attached to a tank containing a sealant; a control unit for the nozzles; and a structure to dry the sprayed coatings. The delivery system may include a heater unit to heat up the color changing material to facilitate the step of drying.

As yet another feature of the exemplary and non-limiting embodiment of the present invention, the apparatus for labeling plant products based on laser activation of a color-changing compound may include a sealant system providing a protective coating or wax material or the like to the produced mark.

As yet another feature of the exemplary and non-limiting embodiment of the present invention, the apparatus for labeling plant products based on laser activation of a color-changing compound may include a vision system consisting of a visible or infrared light emitter, a visible or infrared light detector, a processing unit, and a control unit.

### DESCRIPTION OF THE DRAWINGS

For a better understanding of the invention, reference may be made to the accompanying drawings in which:

FIG. 1 is a schematic view of an exemplary and non-limiting embodiment of the present invention;

FIG. 2 is a flowchart of the logic of a preferred embodiment of the present invention.

FIGS. 3A and 3B illustrate cross-sections of a plant product with a coating of a color changing compound on an entire surface and on a portion of a surface, respectively. FIG. 3C depicts a label imaged on the plant product.

FIGS. 4A-4C are flow charts related to processes for compensating for various sizes and shapes of plant products.

### DETAILED DESCRIPTION OF THE INVENTION

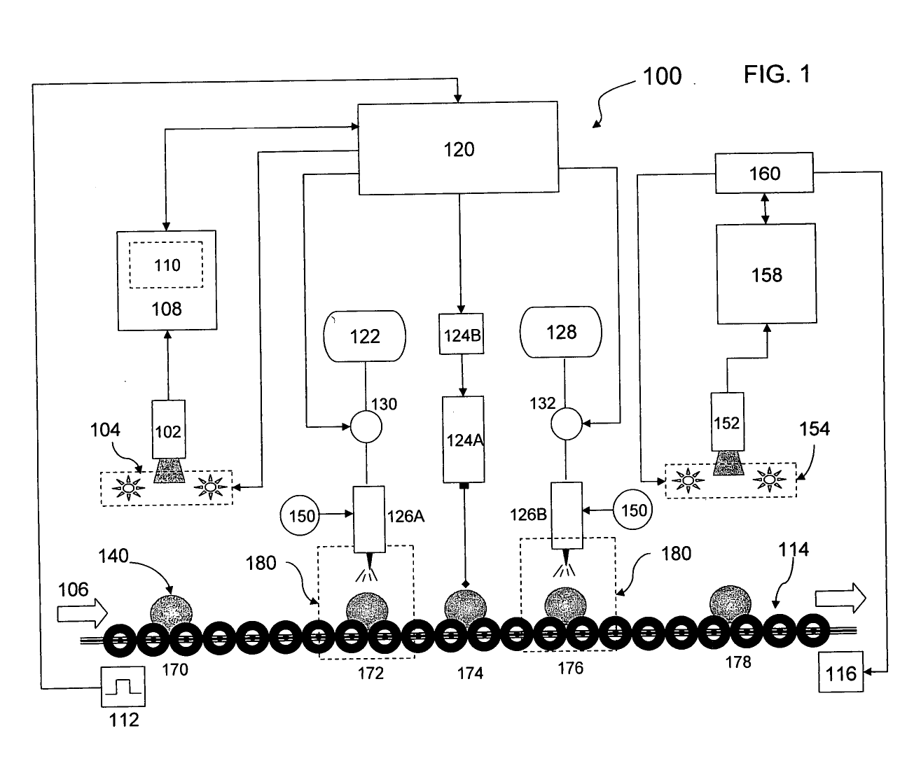

An exemplary and non-limiting embodiment of the present invention provides a method and apparatus for labeling plant products based on laser activation of a color changing compound placed on at least a part of the surface of the plant products. The plant product may be any suitable fruit, including non-citrus and citrus fruit, vegetable, legume, or the like, and will be generally referenced herein as a “plant product.” FIG. 1 illustrates in schematic form a marking system 100 according to an exemplary embodiment of the present invention. The marking system includes a conveying system 114, which may comprise one or more sections, where singled out fruit travels in a given direction 106. In the illustrated exemplary embodiment of the invention, there is only a single section in the conveying system 114 and that section moves at a constant speed. However, as would be understood by one skilled in the art, where plural sections are involved, the conveyors in each section may travel at different speeds and the speed in each section may be controllable. The conveying system 114 can consist of at least one of a spool, cup, belt, and the like, and each section of a plural conveying section system can have different structures. Preferably, each section that is controlled to move independently at a predetermined fixed or variable speed is provided with a source of an encoding pulse 112. In the illustrated system 100, only a single source of a pulse 112 is provided in order to simplify the illustration and not by way of limitation. Multiple pulses and other synchronization techniques may be used, as would be known to those skilled in the art.

A control unit 120 provides communication links to the rest of the marking system 100 in any suitable manner, preferably through Control Area Network (CAN), having an appropriate and conventional communication protocol. The control unit 120 also provides interfacing with the rest of the marking system 100 in any suitable manner, preferably by including a processor, memory, and software having at least one software instruction. The control unit 120 may be located close to the rest of the components of marking system 100 or in a remote location. The control unit 120 may be dedicated to a given marking system 100, or may be centralized to serve multiple marking systems 100. In addition, though the control unit 120 is depicted in FIG. 1 as being a single unit, there is no requirement in the present invention that control unit 120 be assembled as an integrated whole or be assembled in such a way as to exclude components not shown, or shown outside the depicted block.

In an exemplary and non-limiting embodiment of the present invention, a plant product detector 102 is provided at or proximate to the beginning of the system 100, and may be at least one of a photodiode, a photosensor, a camera, a camera equipped with an optical filter, a CCD sensor, or any other suitable type of detector or combination of detectors. The plant product detector 102 can optionally be equipped with additional optics, including but not limited to lenses, polarizers, optical filters, a photometric unit such as a grate or prism, or the like. In an exemplary but non-limiting embodiment of the present invention, the plant product detector 102 is of the form of an area-scan camera equipped with an optical filter tuned to the frequency and/or wavelength of the light from illumination unit 104 that is reflected from the region under observation. One of ordinary skill in the art could readily utilize a line-scan camera for instance, with suitable changes to the software and optics of the marking system 100, without departing from the spirit of the present invention. Similarly, one or more of other types of detectors with appropriate arrangements of software and optics could readily be implemented for use with the present invention.

Illumination unit 104 may be at least one of a light-emitting diode (LED), a broad-spectrum lamp, a broad-spectrum lamp equipped with an optical filter, a laser, or any other suitable source of illumination, including combinations of illumination sources. The illumination unit 104 can optionally be equipped with additional optics (lenses, polarizers, or the like). Preferably illumination unit 104 is of the LED type. Additionally, it is preferred that intensity of light from illumination unit 104 is controlled by control unit 120.

In an exemplary and non-limiting embodiment of the present invention, a plant product detector 102 may be connected to a processor unit 108, containing a memory 110, and software having at least one software instruction. The processing unit 108 is adapted to continually receive data representing images of the conveying system 114 at the region under observation and generated by the plant product detector 102, and includes software to determine when there is a plant product in the field of view of the plant product detector, the size of the plant product, and other information pertaining the plant product that may be pertinent to the location, size, content or type of label that is to be applied to the plant product. Memory 110, which may be a RAM or ROM type storage, may be used to store all the label marks pertaining to a specific operation in such a manner that it can be accessed by processing unit 108 for retrieval of relevant data and/or instructions. Thus, a single label or a variety of different labels, constructed from a single data image or plural overlapping data images, may be created, as desired. Processing unit 108 selects a specific label and accesses the necessary printing data according to the plant product information identified, or according to printing data that is calculated, and sends the printing data to the laser marker 124 through the control unit 120. Alternatively, the labels database contained in memory 108 can be sent at once to laser marker control unit 124B or any other intermediate memory, in order to provide quicker access to the database. On the basis of the foregoing arrangement, as would be understood by one skilled in the art, multiple plant product detectors 102 and multiple illumination units 104 and the combination of them can be used to determine plant product label related features for application at a single or multiple marking stations, to track the same or different individual plant products 140. For a single plant product 140, a single or several images may be taken. There is no requirement in the present invention that the plant product detector 102 and related components 104, 108, and 110 be of the aforementioned type. For example, in an operation where labels are always the same and plant products are of the same size, a photosensor can replace the plant product detector 102 and related components 104, 108, and 110 for plant product tracking without departing from the spirit and scope of the present invention.

In a preferred embodiment of the present invention, a delivery system includes at least one of a color-changing compound container 122, a valve 130, a nozzle 126A, and source 150 of forced gas, preferably air for the sake of economy. Other types of gases may be used, as desired, where the environment for the application of the color changing compound necessitates use of such other gas. In the illustrated exemplary embodiment, the delivery system is located at a fixed distance 172 from the initial location 170 where the plant product detector 102 is stationed for identification of a valid plant product image in a manner known in the art. The control unit 120 keeps track of the speed of the one or more segments of the conveyor system 114 through the detection of one or more encoding pulses 112. In the illustrated exemplary embodiment, where there is only a single conveyor section moving at a fixed speed and a single encoding pulse, the control unit 120 activates nozzle 126A through valve 130 after a predetermined delay from the time that the pulse 112 is generated. The delivery system also includes forced air 150 whose pressure can be controlled so the amount of fluid sprayed by the nozzle 126A can be controlled by regulating the time the valve 130 is open. Optionally, the spraying nozzle 126A may be at least one of a single nozzle, and a combination of nozzles, a brush, a combination of the aforementioned, and any applicator that may provide a fluid on all or a desired portion of the plant product.

Optionally, the spraying nozzle 126A may be attached to an additional tank (not shown) containing flushing solvent for maintenance. The valve 130 may be controllably switched between the solvent tank and the color changing compound tank 122 in response to signals from control unit 120. There is no requirement in the present invention that the delivery system includes a dedicated tank 122. For example, the color-changing compound can be incorporated into the wax containers already used during normal operations without changing the scope and spirit of the present invention.

The exemplary delivery system 100 also may include a forced gas blower 180, preferably an air blower, to assist in shortening the drying time of the coated color-changing compound. As would be understood by those skilled in the art, typically, the mark quality improves if the color changing compound coating is completely dry prior to the laser applying the mark to the plant product.

Optionally, a separate heater may be attached prior to the spraying nozzle 126A. The heater (not shown) increases the color-changing compound temperature prior spraying to further assist in shortening the drying time of the aforementioned coated compound.

In the exemplary embodiment of the present invention in FIG. 1, the marking sub-system includes at least one combination of a laser 124A and a laser control unit 124B. In the illustrated embodiment where there is only one marking sub-system, it is located at a predetermined distance 174 from the initial location 170 where the plant product detector 102 detected a valid plant product image. The control unit 120 keeps track of the speed of the conveyor system 114 or relevant section thereof, for example, through the use of encoding pulse 112. Optionally, if plural conveyor sections are used, a separate pulse for each section can be employed. In this manner, the control unit 120 can activate the laser 124A after a predetermined delay. In an exemplary and non-limiting embodiment of the present invention, a laser control unit 124B receives encoded instructions from control unit 120 for laser triggering and for selecting the appropriate label from the label database in memory 110. As would be understood by one skilled in the art, the laser control unit may itself have a processor and memory that can control the generation of an image based on a command from the control unit 120. The laser can operate in one of a dot matrix mode or a continuous-wave, scribing mode. Other centralized or distributed control arrangements are encompassed by the present invention. In any event, the same or different labels, selected according to predetermined parameters for the plant products, may be applied in different sizes, colors or areas of the plant product in a controlled manner.

On the basis of the foregoing logic and with reference to the arrangement in FIG. 1, as would be understood by one skilled in the art, multiple marking systems 124 may be used for a single plant product or for multiple conveying systems marking several independent plant products simultaneously. As already noted, the plant products may have variable shapes, sizes and surface contours. In one preferred embodiment, the laser 124A includes beam steering optics to produce the mark on the plant product. Optionally, the mark can be produced with any other suitable image generator such as image projection or diffractive elements. In an exemplary embodiment of the present invention, the marker 124A is of at least one of a CO2 type operating at 10600 nm with a maximum power of 10 W. It would be understood by someone skilled in the art that a different operating wavelength and power output may be used without departing of the scope and spirit of the present invention.

In a preferred embodiment of the present invention, a sealant system includes at least one of a sealant compound container 128, a valve 132, a nozzle 126B, and forced gas supply 150, preferably one providing air. The sealant system may be located at a predetermined distance 176 from a location 170 where a plant product detector 102 identified a valid plant product image. In the illustrated exemplary embodiment, the control unit 120 keeps track of the conveyor system 114 speed on the basis of the encoding pulse 112. As already noted, the speed may be steady or variable, and there may be one or plural conveyor sections that are commonly or independently monitored and controlled. In any of a variety of arrangements, the control unit 120 activates nozzle 126B through valve 132 after a predetermined delay. The sealant system also includes forced gas source 150, which preferably provides air, whose pressure can be controlled so the amount of fluid sprayed by the nozzle 126B can be controlled by regulating the time the valve 132 is open. Optionally, the spraying nozzle 126B may be at least one of a single nozzle, and a combination of nozzles, a brush, a combination of the aforementioned, and any other suitable applicator.

Optionally, the spraying nozzle 126B may be attached to an additional tank (not shown) containing flushing solvent for maintenance. The valve 132 may be controlled to switch between the solvent tank and the sealant compound tank 128 through control unit 120. There is no requirement in the present invention that the sealant system includes a dedicated tank 128. For example, the sealant compound can be pumped from wax containers that already are used during normal operations without changing the scope and spirit of the present invention.

Optionally, the sealant system also includes at least one of a forced gas blower 180 to assist in shortening the drying time of the coated sealant compound.

Optionally, a separate heater may be attached prior to the spraying nozzle 128A. The heater (not shown) increases the sealant compound temperature prior spraying to further assist in shortening the drying time of the aforementioned coated compound. The mark quality and legibility remains longer if the sealant compound coating is completely dry prior to final packing of the plant product.

In an exemplary and non-limiting embodiment of the present invention, a mark verification system includes at least one of a mark quality detector 152, an illumination source 154, a processing unit 158, and a control unit 160.

In one exemplary embodiment of the present invention, a mark quality detector 152 may be at least one of a photodiode, a photosensor, a camera, a camera equipped with an optical filter, a CCD sensor, or any other suitable type of detector 152 or combination of detectors 152. The mark quality detector(s) 152 can optionally be equipped with additional optics (lenses, polarizers, optical filters, a photometric unit such as a grate or prism, or the like). In a preferred embodiment of the present invention, the mark quality detector 152 is of the form of an area-scan camera equipped with an optical filter tuned to the illumination 154. One of ordinary skill in the art could readily utilize a line-scan camera for instance, with suitable changes to the software and optics of the marking system 100 without departing from the spirit of the present invention.

Illumination source 154 may be at least one of a light-emitting diode (LED), a broad-spectrum lamp, a broad-spectrum lamp equipped with an optical filter, a laser, or any other suitable illumination source or combination of illumination sources. The illumination source 154 can optionally be equipped with additional optics (lenses, polarizers, or the like). Preferably, illumination source 154 is of the LED type. Additionally, it is preferred that the intensity of illumination source 154 be controllable by control unit 160, or centrally by a common control unit.

In a preferred embodiment of the present invention, a mark quality detector 152 may be connected to a processor unit 158, containing software having at least one software instruction. The processing unit 158 continually receives images from the region of the conveying system 114 under observation, as generated by the mark quality detector 152, and includes software to determine the presence of a plant product in the detected image. The processing unit also is operative to determine at least one of a presence of a mark on the plant product, mark legibility assurance, and mark type verification. On the basis of the foregoing arrangement, as would be understood by one skilled in the art, multiple mark quality detectors 152 and multiple illumination sources 154, and any combination of them, may be used to determine an appropriate plant product label having desired features for application at a single or multiple marking stations, and to track the same or different individual plant product(s) 140. For a single plant product 140, one or more images may be taken. There is no requirement in the present invention that the mark quality detector 152 and related components 154, and 158 be of the aforementioned type, without departing from the spirit and scope of the present invention.

In an exemplary embodiment of the present invention, the processing unit 158 includes software for assigning a category to the mark quality and legibility, which generally may be a reject/accept decision based on predetermined criteria. In an exemplary and non-limiting embodiment of the present invention, the processing unit 158 sends the encoded decision to the mark quality control unit 160, which includes communication link with ejection system 116 and software for assigning the plant product to different ejection locations, according to the encoded decision.

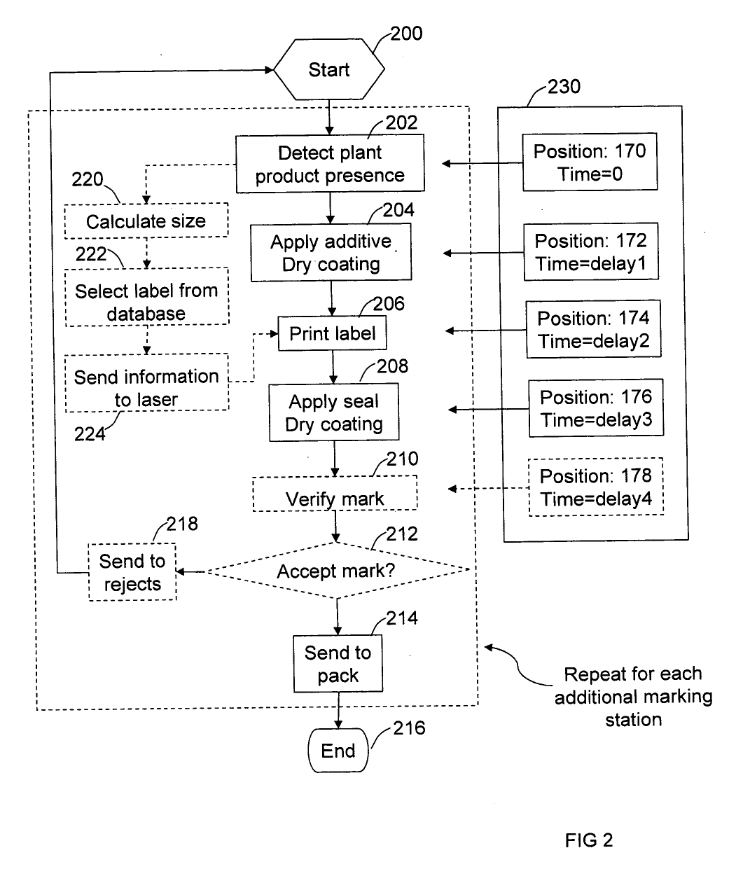

FIG. 2 illustrates a flowchart of the logic of an exemplary embodiment of the present invention as illustrated in FIG. 1. As already noted, however, the system arrangement is not limited thereto and there are many variations in the arrangement that can be envisioned by one skilled in the art, and the operation of the system would be defined by a logic based upon the principles in the following description. In FIG. 2, control begins at start block 200 and passes to first control block 202, where the plant product detector 102 and related components detect the presence of the plant product 140. A sequence in control block 230 is started at location 170, Time=0. Simultaneously, control then proceeds to optional block 220 (as shown by the dotted line) where plant product relevant information is calculated. In the same optional branch, control passes to block 222 where a label, image, design, character or mark is selected from the database. Control then passes to optional block 224 where information related to the desired image is sent to the laser 124. At the same time, control block 202 passes control to block 204, which provides data and commands for the application of the color changing compound to at least a portion of the surface of plant product 140, and is dried. For control block 204, the sequence status is location 172, Time=delay1, where delay1 is calculated from the conveying system speed and the fixed distance between positions 170 and 172.

After control block 204, control passes to control block 206 where the label, character, image, design or mark is printed onto the color changing coating deposited on the plant product 140 by appropriate control of the laser. For control block 206, the sequence status is location 174, Time=delay2, where delay2 is calculated from the conveying system speed and the fixed distance between positions 170 and 174.

After control block 206, control passes to control block 208 where the sealant compound is applied onto the plant product 140 over the label, character, image, design or mark and dried. For control block 208, the sequence status is location 176. Here, Time=delay3, where delay3 is calculated from the conveying system speed and the fixed distance between positions 170 and 176.

After control block 208, control passes to optional control block 210 (as indicated by the dotted line) where the mark is verified for quality and legibility. After control block 210, control passes to the optional accept/reject decision block 212. If the mark is accepted the sequence status is location 178, Time=delay4, where delay4 is calculated from the conveying system speed and the fixed distance between positions 170 and 178. Then, the plant product may be directed to the normal operation locations or predetermined packing locations. If the mark is not accepted, control passes to control box 218 where the plant product is sent to a specific reject location, usually a wash station and ultimately back to the marking station. All the time delays aforementioned can be measured in physical time units or derived from conveyor encoded pulses.

According to the foregoing description, a common conveyor or a plurality of conveyor sections operating at a constant speed is assumed. However, it would be understood by one skilled in the art that the conveyor may comprise plural sections each operating at a predetermined speed that is the same or a different speed, and each being individually controlled, in order to optimize the processing and throughput of the system or to handle processing from a plurality of sources. In such case, appropriate modification of the foregoing process would be made to detect a location of plant product at a particular conveyor section and control synchronization of speed and processing.

Further, while a conveyor or conveyors that carry the plant products at arbitrary positions on the conveyor are described in the exemplary embodiment, such that a position and parameter detector is needed, one skilled in the art would understand that the plant product may be placed in holders at predetermined positions on the conveying mechanism such that the location of the plant product is pre-established and the control of various operations along the conveying mechanism would take place without the need for optical detectors.

According to the foregoing description, the sealant coating is applied in block 208 after the printing step, but as would be understood by one skilled in the art, the sealant coating may be sufficiently transparent such that the printing of the label, character, design or other image may occur by transmitting the light beam through such coating. Thus, the sealant coating may be applied prior to the printing step, or may be applied both prior to and after the printing step. Moreover, the sealant step may be eliminated altogether.

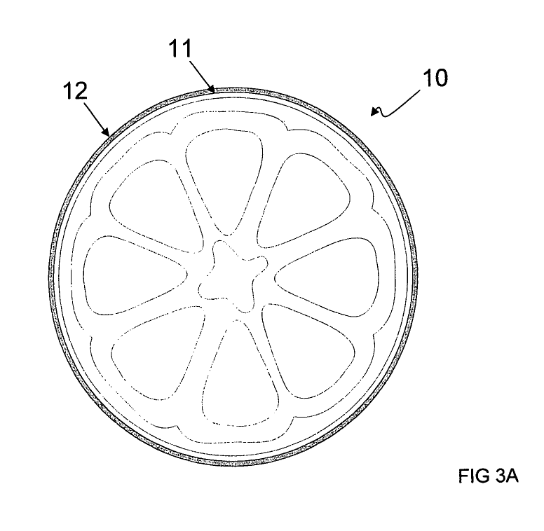

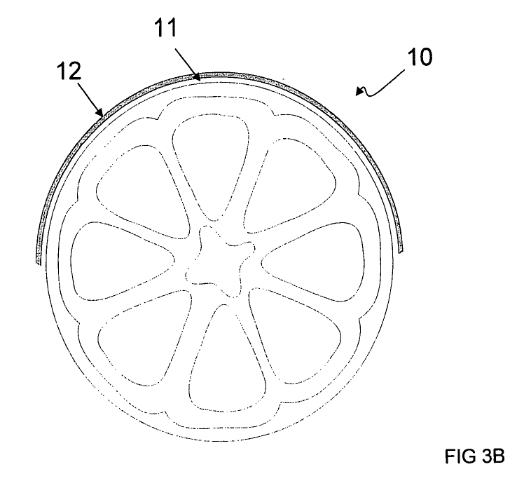

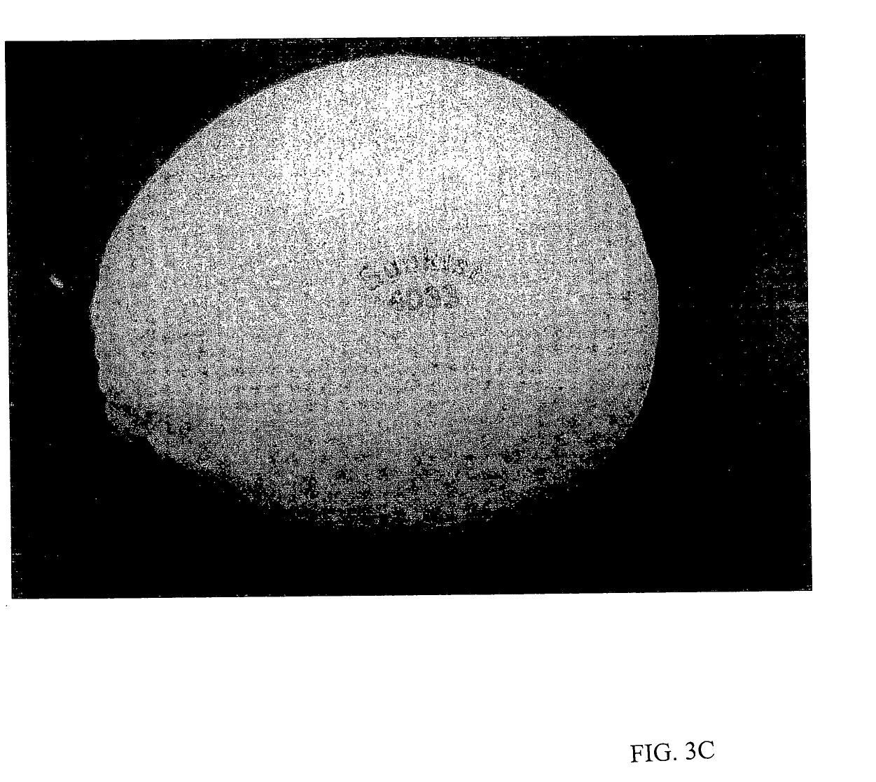

FIG. 3A illustrates a cross-section of a plant product 10 with a coating 11 of a color changing compound on an entire surface and a coating of a sealant 12 over the colorant. FIG. 3B illustrates a cross-section of a plant product 10 with a coating 11 of a color changing compound on a portion of a surface and a coating of a sealant 12 over the entire surface. The Figures do not show the coatings drawn to scale, as would be understood by one skilled in the art. FIG. 3C illustrates a label developed on the plant product by laser development of a color changing coating.

Plant products may be of various sizes, even for products of a given variety, and such products may vary widely in shape and surface texture. For example, oranges may have shapes that vary from perfectly round to oval or elliptical shapes, or even shapes with bulges or the like. Moreover, the sizes may vary within a certain range, yet the variation may have some affect on the focal plane of a laser. Of course, the surface of a citrus fruit, for example, may vary in texture, thereby having some impact on the manner in which the label may be applied. Thus, it would be advantageous to have the laser labeling system provide compensation for such variations, either on a group or individual piece by piece basis.

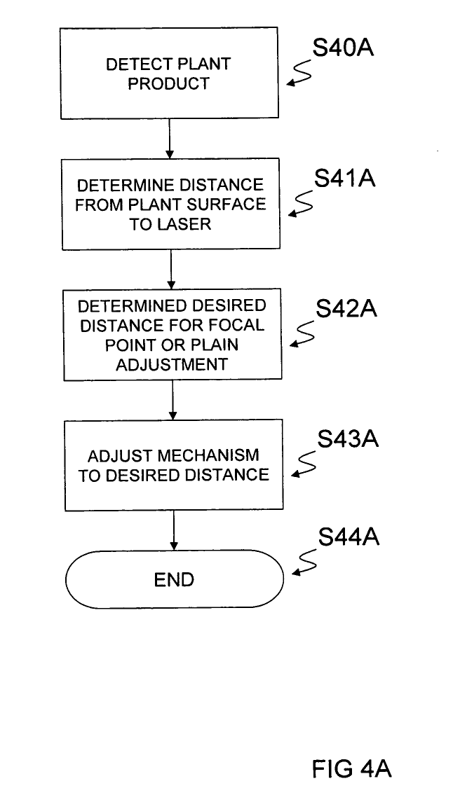

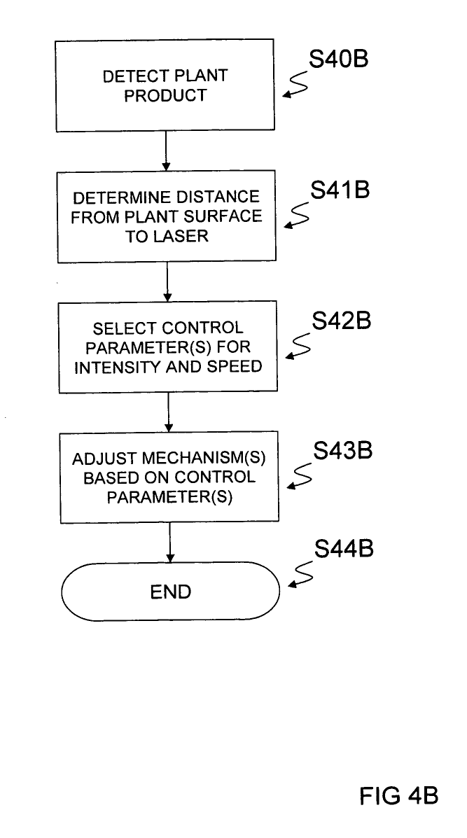

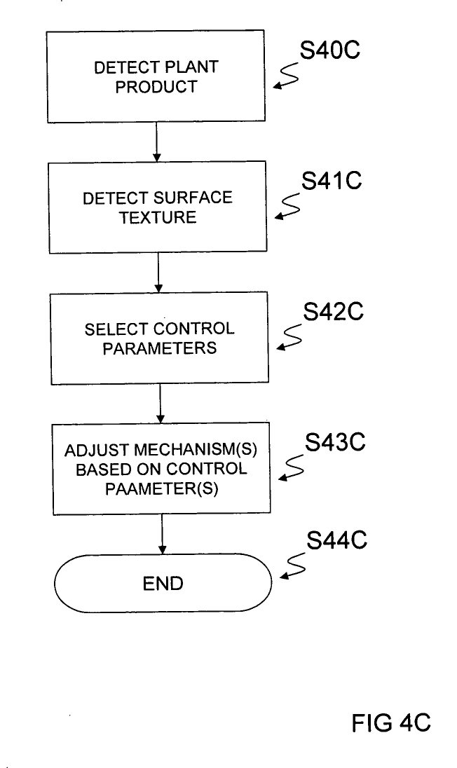

One approach used for a compensation for variations in size, shape, and surface texture has been implemented. Size variation concerns only the actual distance measured from the top of the plant product to the laser printing head. To adjust for fruit size difference, the laser printing head is equipped with optics with large focal depth. In addition, on the basis of a detected actual distance by well known sensor or vision techniques, suitable signals are sent to the laser control unit to adjust intensity and adjust the laser internal marking speed setting. When there is a large variation in size, for instance lemons and grapefruit, the system may be located on a lifting mount that will change a distance uniformly for all plant products of a given type or size within a given lot or run. Thus, with reference to FIG. 4A, in a first step S40A, an individual plant product is detected and in step S41A the distance from the laser source is determined, for example, using detector 102 in the exemplary system of FIG. 1 or other desirably located detector. On the basis of the detected distance, in a step S42A, a determination is made of a distance by which the laser focal point or plane needs to be adjusted, if at all. The distance or adjustment quantity can be selected from a look-up table or similar conventional data retrieval technique in control unit 120. In a step S43A, the focal length is adjusted, for example, by moving the laser 124A mount, adjusting optics or even moving a plant product holder. Finally, in a step S44A, the process ends with the laser thereafter being controlled to produce the label.

When there is a small to medium variation in size, the intensity of the laser may be adjusted along with a variation in laser internal marking speed setting, for an individual product or for all plant products of a given type or size within a given lot or run. Thus, with reference to FIG. 4B, in a first step S40B, an individual plant product is detected and in step S41B the distance from the laser source is determined, for example, by detector 102. On the basis of the detected distance, in a step S42B, a determination is made by control unit 120 of a value by which the intensity of the laser must be adjusted for that distance and, if necessary, the laser speed setting to ensure an appropriate clarity to the resulting image. The adjustment quantity can be selected from a look-up table or similar conventional data retrieval technique. In a step S43B, the intensity and laser speed are adjusted, for example, by adjusting appropriate control parameters for control unit 124B. Finally, in a step S44B, the process ends with the laser intensity and scan, including direction and speed, thereafter being controlled to produce the label.

Variations in shape similarly can be compensated for, at a more basic level, by use of the same optics with a large focal depth that is arranged to compensate for variations in plant product size due to the round shape of most fruits. If additional adjustment is required, delay times can be adjusted slightly to mark in the same general area, for instance at the thickest zone in a pear.

With respect to variations in surface texture, citrus fruit presents a porous texture and the printing requires a fairly uniform coating. The viscosity and composition of the color changing material is modified to allow optimal spraying of the coating to fill the fruit pores. In the exemplary and non-limited embodiment of this invention, a color changing material similar to the ones described in U.S. Pat. No. 6,888,095 (hereafter referred as SWD material) was modified for the specific use in this embodiment. As received from the material manufacturer (Sherwood Technologies, Inc.), the SWD material is unsuitable for use in the exemplary embodiment of the invention. The liquid is comprised of a powder and denatured ethanol as a liquefying agent. Directly from the manufacturer it has a low viscosity (excessive ethanol) and relatively large particle size (the powder is too coarse). The excessive ethanol extends the drying time to an extent that requires very long drying time or unpractical high temperatures to adequately dry the SWD for optimal printing. The particle size diminishes the spray nozzle ability to atomize the SWD material sufficiently to apply it evenly on the surface of the plant product; it also contributes to clogging of the system once the viscosity is increased. Measured conditions of the liquid as supplied are a particle size of either <70 micron or <45 micron depending on how it is ordered; and a viscosity of 270 centistokes.

In the tests conducted, it was found that in order to spray and dry the SWD in the exemplary embodiment of this invention the particle size must be reduced to <10-microns (<5 is optimal). The viscosity must also be increased to 525-550 centistokes. The process required to do this takes 5-7 days. First the particle size must be reduced. This is accomplished by placing the liquid in a vibratory tumbler with a hard; fine grain, ceramic grinding media that has been run on its own to polish the media. The SWD is added to the media with enough ethanol to reduce the viscosity to <25 centistokes. At this low viscosity the powder grinds to <10-micron particle size in 4-6 days. Higher viscosities will not allow the media to grind the particles below 30 microns. Following the grinding process the added ethanol must be evaporated off. To achieve this, an open topped beaker was setup along with an agitation motor, and a set of fans. Two points that must be monitored is the evaporation cannot be done during days of high humidity and the liquid must be vigorously agitated. Excess humidity causes the material to aggregate back into larger particle clusters. Slow moving areas on the surface of the liquid cause the formation of flakes in the liquid. The evaporation is continued until the viscosity of the liquid reaches a viscosity of 525-550 centistokes. After this is done the liquid is filtered through a 40-micron screen. In the tests conducted, it was found that the flakes of material are usually large (>100 micron) thus this large opening screen allows the liquid to pass through and blocks any flakes that would otherwise clog the delivery system.

Additional uniformity is achieved by adjusting the amount of material sprayed, for example, by adjusting the flow of liquid and air pressure in the sprayer nozzles, and also by adjusting the time the nozzle is active. Where there are variations among plant products in surface texture from lot to lot or even within the same lot, an automatic process could be used. For example, as illustrated in FIG. 4C, an individual plant product may be presented to a detector 102 in step S40C and a surface texture may be detected in step S41C. Then a control parameter may be selected in step S42C on the basis of a look-up table or the like and control unit 120 may control one or more of the amount of material provided to the valve 132 for nozzle 126B, the viscosity of the material based on a blending of different base and solvent materials, a duration of spraying, or the like. The actual adjustment of parameters for the relevant mechanisms in the spraying process by one or more of the variable parameters (nozzle, valve, etc.) would be conducted in step S43C. The process then ends in step S44C and the coating process proceeds. The resultant uniform coating may be controlled for each individual plant product or may be controlled for a group of products based on a detected surface texture value of one representative product.

While the foregoing description is directed to certain exemplary embodiments, the invention disclosed herein is not limited thereto, but is to be defined by the appended claims.

We claim:

1. A method for labeling plant products comprising:
conveying a plant product to plural locations;
detecting the presence of the plant product at a first location;
applying a coating of a color change compound on at least a portion of a surface of the plant product as said plant product at a second location; and
selectively applying light to at least a portion of the surface coated with the color changing compound at a third location.

2. The method of claim 1, further comprising applying a coat of sealant material over at least the portion of the surface to which light is applied.

3. The method of claim 1, further comprising verifying the quality of an image created by the light applying step at a fourth location.

4. The method of claim 3, further comprising directing the plant product to one of plural exit locations as said plant product is conveyed.

5. The method of claim 1 wherein the plant product is at least one of a citrus fruit, non-citrus fruit, vegetable, and legume.

6. The method of claim 1, wherein the step of conveying comprises:
supplying a plurality of plant products to a common conveying mechanism and transporting the plant products serially on said common conveying mechanism at a constant or variable speed;

7. The method of claim 1, wherein the step of detecting includes determining at least one parameter selected from the group comprising size, color, quality, orientation, type, and any texture, and the method further comprises specifying data for use in said selectively applying light step on at least the basis of said at least one parameter.

8. The method of claim 1, wherein the step of applying a coating further comprises drying the coating.

9. The method of claim 1, wherein the selectively applying light step includes applying light in a pattern comprising at least one of a symbol, character, design, label and image.

10. The method of claim 1, wherein said selectively applying light step is implemented by a steerable laser beam.

11. The method of claim 10, wherein the laser is of the CO2 type emitting at substantially 10600 nm.

12. The method of claim 4, wherein the step directing the plant product comprises redirecting the plant product having the same label to a predetermined location for packaging.

13. The method of claim 1 comprising a series of single or plural coatings and applying steps for a single plant product.

14. An apparatus for labeling plant products based on light activation of a color-changing compound compromising:
a conveying system for transporting individual plant products in series at one of a constant or variable speed;
at least one detector for detecting the presence of the plant product;
a color changing compound delivery system for coating at least a portion of the surface of the plant product;
a marking system for selectively applying light to said portion of the surface of the plant product that has been coated; and
a control unit responsive to said at least one detector for controlling said color changing compound delivery system and said marking system to generate an image on a surface of said plant product.

15. The apparatus as defined in claim 14 further comprising a sealant delivery system for providing a coating on at least a part of the surface of said plant product.

16. The apparatus as claimed in claim 15 wherein said sealant delivery system comprises at least one of a spraying nozzle, a brush, and a liquid applicator.

17. The apparatus as claimed in claim 14, further comprising an image detecting system, coupled to said control system, for recognition of the image and assigning an encoded instruction for redirection.

18. The apparatus of claim 14, wherein the conveying system is operative to transport each plant product at a constant speed, to provide an encoded signal for plant product location, and further comprises means for ejecting the plant product at a specific location.

19. The apparatus of claim 17, wherein the image detecting system comprises at least one of a photodiode, a photosensor, a camera, a camera with an optical filter, and a CCD sensor, and wherein the illumination of the imaging system is provided by at least one of a light-emitting diode, a broad-spectrum lamp, a broad-spectrum lamp including an optical filter, and a laser.

20. The apparatus claimed in claim 19, wherein the image detecting system comprises in a camera with an optical filter and the illumination provided by light-emitting diodes emitting in the range of 700 nm to 900 nm.

21. The apparatus claimed in claim 14 wherein the control unit generates an image of at least a part of the plant product and includes software for at least one of: plant product presence detection, size calculation, conveyor speed calculation, and plant product routing.

22. The apparatus claimed in claim 14, wherein the control unit comprises a network for communication with plural system components.

23. The apparatus claimed in claim 14, wherein the color changing compound delivery system comprises at least one of a spraying nozzle, a brush, and a contact applicator.

24. The apparatus claimed in claim 14, wherein the color changing compound delivery system further comprises a pressurized system.

25. The apparatus claimed in claim 14, wherein the plant product is at least one of a citrus fruit, non-citrus fruit, a vegetable, a legume, and the like.

26. The apparatus claimed in claim 14, wherein the marking system comprises a laser of the CO2 type emitting at substantially 10600 nm wavelength with a maximum output power of 10 W.

27. The apparatus claimed in claim 14, wherein the marking system comprises a laser equipped with steering-beam optics.

28. The apparatus claimed in claim 15, wherein the sealant delivery system comprises a pressurized system.

29. The apparatus of claim 17, wherein the image detecting system comprises a secondary control unit having a processor, memory, and software with at least one software instruction.

30. The apparatus of claim 29, wherein the secondary control unit generates an image of the plant product and includes software for at least one of: plant product presence detection, plant product label recognition, rejection/acceptance assignation, and communication link.

31. The method of claim 1, further comprising the step of determining at least one of the size, texture and shape of a plant product and the step of adjusting at least one of the laser distance to the plant product, the laser focus and the laser intensity.

32. The method of claim 1, further compromising the step of modifying the color changing compound to achieve optimal viscosity and particle size.

33. The apparatus of claim 14, further comprising:
a detector system for determining at least one of the size, texture and shape of a plant product, and
an adjustment unit coupled to the marking system and responsive to the detector system for adjusting at least one of a laser distance to the plant product, a laser focus and a laser intensity.
